(19) United States
(12) Patent Application Publication
(10) Pub. No.: US 2020/0402160 A1
(43) Pub. Date: Dec. 24, 2020

(54) METHOD OF DETERMINING WHETHER OR HOW TO PRESENT LOAN OFFER TO USER, INFORMATION PROCESSING APPARATUS, AND NON-TRANSITORY RECORDING MEDIUM

(71) Applicant: Mercari, Inc., Tokyo (JP)

(72) Inventors: Satoshi KAJI, Tokyo (JP); Daisuke TORIGOE, Tokyo (JP)

(21) Appl. No.: 16/888,130

(22) Filed: May 29, 2020

(30) Foreign Application Priority Data
Jun. 20, 2019 (JP) 2019-114945

(51) Int. Cl. G06Q 40/02

(52) U.S. Cl. CPC G06Q 40/025

(57) ABSTRACT

A method of determining whether or how to present a loan offer to a user includes determining, by at least one processor, whether or how to present a loan offer to a user on the basis of the user's financial demand.

### BACKGROUND OF THE INVENTION

### 1. Field of the Invention

The present disclosure relates to a method of determining whether or how to present a loan offer to a user, an information processing apparatus, and a non-transitory recording medium.

### 2. Description of the Related Art

In the related art, a technology for loaning to a user via a network such as the Internet is known (see, for example, Japanese Laid-Open Patent Application No. 2017-146900).

### SUMMARY OF THE INVENTION

A method of determining whether or how to present a loan offer to a user according to an embodiment of the present disclosure includes determining, by at least one processor, whether or how to present a loan offer to a user on the basis of the user's financial demand.

Other objects, features and advantages will become more apparent from the following detailed description when read in conjunction with the accompanying drawings.

### BRIEF DESCRIPTION OF DRAWINGS

FIG. 1 is a diagram depicting a configuration of a communication system according to an embodiment of the present disclosure;

FIG. 2 is a view depicting an example of a hardware configuration of an information processing apparatus according to the embodiment.

FIG. 3 is a diagram depicting an example of a block diagram for illustrating a functional configuration of a server and a terminal according to the embodiment;

FIG. 4 is a diagram depicting an example of a sequence of processing of the communication system according to the embodiment;

FIG. 5 is a flowchart depicting an example of financial demand estimating processing according to the embodiment;

FIG. 6A is a view depicting an example of settlement user information stored in a settlement user information storage unit according to the embodiment;

FIG. 6B is a view depicting an example of transaction user information stored in a transaction user information storage unit according to the embodiment;

FIG. 7A is a diagram depicting an example of a display screen page displayed at a terminal according to the embodiment;

FIG. 7B is a diagram depicting an example of a display screen page displayed at the terminal according to the embodiment; and

FIG. 7C is a diagram depicting an example of a display screen page displayed at the terminal according to the embodiment.

### DETAILED DESCRIPTION OF THE EMBODIMENTS

According to the related art described above, it may be impossible to implement a suitable loan offer. A purpose of the present disclosure is to provide technology that enables implementing a suitable loan offer.

### <Legal Compliance>

The technology disclosed herein, when implemented, is implemented in compliance with the laws and regulations of a country in which the technology is implemented. In addition, the technology disclosed herein is implemented with any modification, substitution, variation, or the like that may be made by one of ordinary skill in the art necessary to comply with the laws and regulations of the country.

A method of implementing a suitable loan offer for a user according to the present disclosure will now be described with reference to the drawings.

### <System Configuration>

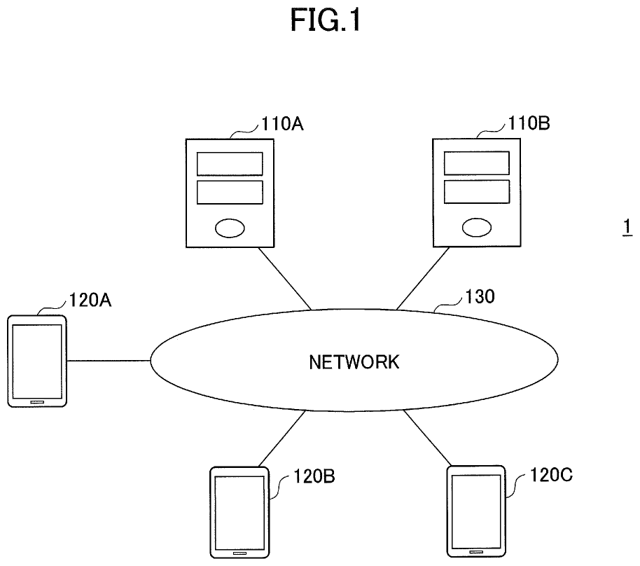

FIG. 1 is a diagram depicting a configuration of a communication system 1 according to an embodiment of the present disclosure. As disclosed in FIG. 1, in the communication system 1, servers 110A and 110B are connected to terminals 120A, 120B, and 120C via a network 130.

In the present disclosure, in a case where it is not necessary to distinguish between the servers 110A and 110B, each of the servers 110A and 110B may be referred to as a server 110.

In the present disclosure, in a case where it is not necessary to distinguish between the terminals 120A, 120B, and 120C, each of the terminal 120A, 120B, and 120C may be referred to as a terminal 120 (an example of an “information processing terminal”).

In the present disclosure, in a case where it is not necessary to distinguish between the servers 110 and the terminals 120, each of the servers 110 and the terminals 120 may be referred to as an information processing apparatus 200. The number of the information processing apparatuses 200 connected to the network 130 is not limited to the number of the information processing apparatuses 200 depicted in the example of FIG. 1.

A server 110 provides a predetermined service via the network 130 to a terminal 120 used by a user. The predetermined service may be, but is not limited to, a settlement service, a financial service, an electronic commerce service, a social networking service (SNS) such as a messaging service using instant messaging, a content-providing service of providing content such as music, videos, books (including comic strips or the like), or the like. The electronic commerce service may be, for example, an Internet mail order service, an interpersonal transaction service such as a flea market service or an online auction service, an instant purchase (pawnbroker) service, or the like.

The financial service may be, for example, a loan service of providing a loan (that may be a small-loan lending service). The financial service may be a service of performing futures trading (or margin trading) of handling one of various trading objects such as stocks, a commodity such as gold or crude oil, or virtual money, foreign exchange (FX) (foreign exchange margin trading), stock trading, or the like. Such an electronic commerce service and a content-providing service are examples of “transaction services”. A server 110 may provide predetermined services to one or more terminals 120 so that the users can use the predetermined services via the terminal 120.

A terminal 120 is, for example, a terminal such as a user's smartphone or the like, and performs processing to use various services provided by a server 110.

As appropriate, a terminal 120 used by a user X is referred to as a terminal 120X, and user information with respect to a predetermined service associated with the user X or the terminal 120X is referred to as user information X. The user information is information of the user associated with an account used by the user with respect to a predetermined service. User information may be, but is not limited to, information that is input by a user or provided by a predetermined service such as the user name, a user icon image, the user's age, the user's gender, the user's address, a user's hobby, or a user's identifier; user-associated electronic value (e.g., electronic money) balance information; or user-associated credit card information (e.g., a credit card number). In this regard, user information may be any one of these types of information or any combination of these types of information.

The network 130 connects two or more of the information processing apparatuses 200. The network 130 is a communication network that provides a connection path so that a terminal 120 can send data to and receive data from a server 110 as a result of the terminal 120 thus being connected to the server 110 via the network 130.

One or more sections of the network 130 may include wired or wireless networks. The network 130 may be, but is not limited to, an ad hoc network, an intranet, an extranet, a virtual private network (VPN), a local area network (LAN), a wireless LAN (WLAN), a wide area network (WAN), a wireless WAN (WWAN), a metropolitan area network (MAN), a section(s) of the Internet, a section(s) of a public switched telephone network (PSTN), a cellular phone network, integrated service digital networks (ISDNs), wireless LANs, long term evolution (LTE), code division multiple access (CDMA), Bluetooth (registered tradename), satellite communications, or the like; and may be any one of these types of networks or any combination of these types of networks. The network 130 may include one or more networks.

An information processing apparatus 200 may be any information processing apparatus capable of implementing the functions and methods described in the present disclosure.

An information processing apparatus 200 may be, but is not limited to, a smartphone, a cellular phone (a feature phone), a computer (such as, but is not limited to, a desktop computer, a laptop computer, or a tablet computer), a server apparatus, a media computer platform (such as, but not limited to, a cable or satellite TV set top box or a digital video recorder), a handheld computer apparatus (such as, but not limited to, a personal digital assistant (PDA) or an e-mail client), a wearable terminal (such as, but not limited to, an eyeglass-type apparatus or a watch-type apparatus), one of other various types of computers, or a communication platform.

### <Hardware Configuration>

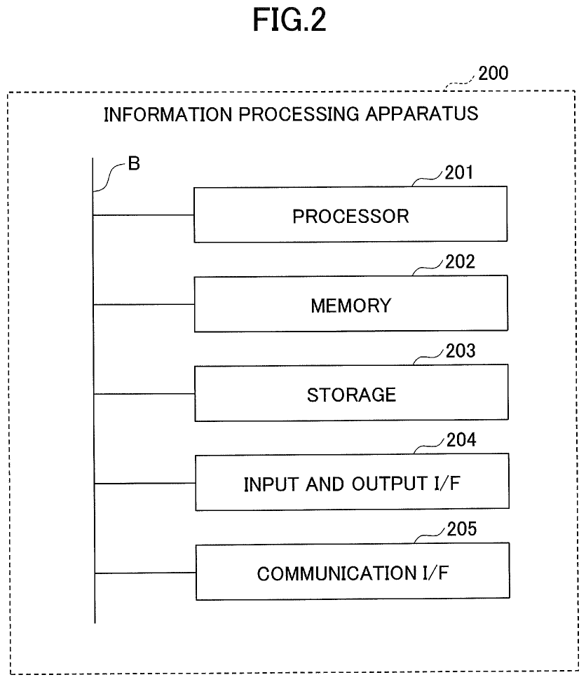

A hardware configuration of an information processing apparatus 200 included in the communication system 1 will now be described with reference to FIG. 2. FIG. 2 is a diagram depicting an example of a hardware configuration of an information processing apparatus 200 according to the embodiment.

An information processing apparatus 200 includes a processor 201, a memory 202, a storage 203, an input and output interface (input and output I/F) 204, and a communication interface (communication I/F) 205. Each component of the hardware of the information processing apparatus 200 is interconnected together by, for example, and not limited to, a bus B.

An information processing apparatus 200 implements the functions and/or methods described in the present disclosure as a result of the processor 201, memory 202, storage 203, input and output I/F 204, and communication I/F 205 functioning in a cooperative manner.

The processor 201 performs functions and methods implemented by codes or instructions contained in programs stored in the storage 203. The processor 201 may be, but is not limited to, a central processing unit (CPU), a micro processing unit (MPU), a graphics processing unit (GPU), a microprocessor, a processor core, a multiprocessor, an application-specific integrated circuit (ASIC), a field programmable gate array (FPGA), or the like, and may implement the disclosed various processes of each embodiment using logic circuits (hardware) or dedicated circuits formed on an integrated circuit (IC) chip, a large scale integration (LSI), or the like. These circuits may also be implemented by one or more integrated circuits, and the plurality of processes of each embodiment may be implemented by one integrated circuit. The LSI may be called VLSI, super LSI, ultra LSI, or the like depending on the degree of integration.

The memory 202 temporarily stores a program loaded from the storage 203 and provides a working area for the processor 201. Various data generated while the processor 201 executes the programs is also temporarily stored in the memory 202. The memory 202 may include, but is not limited to, a random access memory (RAM), a read-only memory (ROM), and so forth.

The storage 203 stores various programs and various data. The storage 203 may be, but is not limited to, a hard disk drive (HDD), a solid state drive (SSD), a flash memory, or the like.

The communication I/F 205 transmits and receives various data via the network 130. Such communication may be implemented either in a wired manner or in a wireless manner, and any communication protocol may be used as long as communication can be implemented. The communication I/F 205 has a function to communicate with another information processing apparatus via the network 130. The communication I/F 205 transmits various data to another information processing apparatus according to an instruction from the processor 201. The communication I/F 205 receives various data transmitted from another information processing apparatus and transmits the received data to the processor 201.

The input and output I/F 204 includes an input device for inputting various user's operations to the information processing apparatus 200 and an output device for outputting processing results processed by the information processing apparatus 200. In the input and output I/F 204, the input device and the output device may be integrated, or may be separated from each other.

The input device is implemented by any one or any combination of all types of devices capable of receiving input from a user and transmitting information corresponding to the input to the processor 201. The input device may be, but are not limited to, hardware keys such as a touch panel, a touch display, or a keyboard; a pointing device such as a mouse; a camera (using an image to receive the input); or a microphone (using a sound to receive the input).

The output device is implemented by any one or any combination of all types of devices capable of outputting processing results of the processor 201. In a case where a result of a process is output as video or a dynamic image, the output device is implemented by any one or any combination of all types of devices capable of displaying display data in accordance with the display data written in a frame buffer. The output device may be, but is not limited to, a touch panel, a touch display, a monitor (such as, but not limited to, a liquid crystal display or an organic electroluminescence display (OELD)), a head mounted display (HMD), a device implementing projection mapping, device generating a hologram, a device capable of displaying an image, text information, or the like in the air (which may be vacuum, alternatively), a speaker (outputting sound), a printer, or the like. These output devices may be capable of displaying display data in 3D.

A program(s) of each embodiment of the present disclosure may be provided in a state of being stored in a computer readable storage medium. The storage medium is a “non-transitory tangible medium” capable of storing a program. The program may be, but is not limited to, a software program or a computer program.

The storage medium may be, where appropriate, one or more semiconductor-based or other integrated circuits (ICs), such as but not limited to a field programmable gate array (FPGA), an application-specific IC (ASIC), a hard disk drive (HDD), a hybrid hard drive (HHD), an optical disc, an optical disc drive (ODD), a magnetooptical disc, a magnetooptical disc drive, a floppy diskette, a floppy disk drive (FDD), a magnetic tape, a solid-state drive (SSD), a RAM drive, a secure digital card or drive, any other suitable storage medium, or any suitable combination of two or more of these types of media. The storage medium may be volatile, non-volatile, or a combination of volatile and non-volatile, where appropriate.

The programs of the present disclosure may be provided to an information processing apparatus 200 also via any transmission medium (such as a communication network or broadcast wave) capable of transmitting the programs

The programs of the embodiments of the present disclosure can also be implemented in a form of data signals embedded in carrier wave, where the programs are embodied by electronic transmission.

The programs of the present disclosure are implemented with the use of a language, such as but not limited to a scripting language such as JavaScript (registered trademark), Python, or the like, a C language, a Go language, Swift, Kotlin, Java (registered trademark), or the like.

At least a section of the processing performed by an information processing apparatus 200 may be implemented by cloud computing using one or more computers.

At least a section of the processing performed by an information processing apparatus 200 may be executed by another information processing apparatus. In this case, at least a section of the processing executed by each function unit implemented by the processor 201 may be executed by another information processing apparatus.

### <Others>

Unless expressly stated otherwise, the specific configuration with respect to determination in the embodiments of the present disclosure is not indispensable. That is, a predetermined process may be performed when determination conditions are met or the predetermined process may be performed when the determination conditions are not met.

In the present disclosure, “at least one of A and B” means “A, B, or both”, unless otherwise specified or otherwise indicated by context. Furthermore, “a”, “an”, or “the” means “one or more” unless otherwise specified or otherwise indicated by context. Accordingly, “an A” or “the A” herein means “one or more A” unless otherwise specified or otherwise indicated by context.

Embodiments of the present disclosure include all modifications and substitutions that may be made by one skilled in the art on the embodiments of the disclosure. The appended claims also cover all modifications and substitutions that may be made by one skilled in the art on the embodiments of the disclosure. In addition, embodiments of the present disclosure include any combination of one or more features of an embodiment of the present disclosure and one or more features of another embodiment of the present disclosure, which combination may be made by a person skilled in the art.

In addition, when an apparatus, a system, or an element of an apparatus or a system, adapted, disposed, capable, configured, capable of being used, or capable of operating to implement a specific function is referred to in the appended claims, the apparatus, the system, or the element of the apparatus or the system thus referred to indicates the apparatus, the system, or the element of the apparatus or the system whether or not the apparatus, the system, or the element of the apparatus or the system is activated, turned on, or unlocked as long as the apparatus, the system, or the element of the apparatus or the system is adapted, disposed, capable, configured, capable of being used, or capable of operating to implement the specific function.

In addition, unless expressly stated otherwise, consent of the user may be obtained previously or immediately prior to implementation of any embodiment of the present disclosure. Such consent to be obtained may be comprehensive or may be obtained on a case-by-case basis.

### Embodiments

Embodiments of the present disclosure offers a loan to a user on the basis of information with respect to the user.

According to the embodiments, for example, it is possible to implement a suitable loan offer to a user. Also, advantageous effects can be obtained such that the user's time and effort in, for example, obtaining a loan can be reduced, resulting in reduced load on a terminal 120 or a server 110 and reduced load on the network 130 between the terminal 120 and the server 110.

### <Functional Configuration of Embodiments>

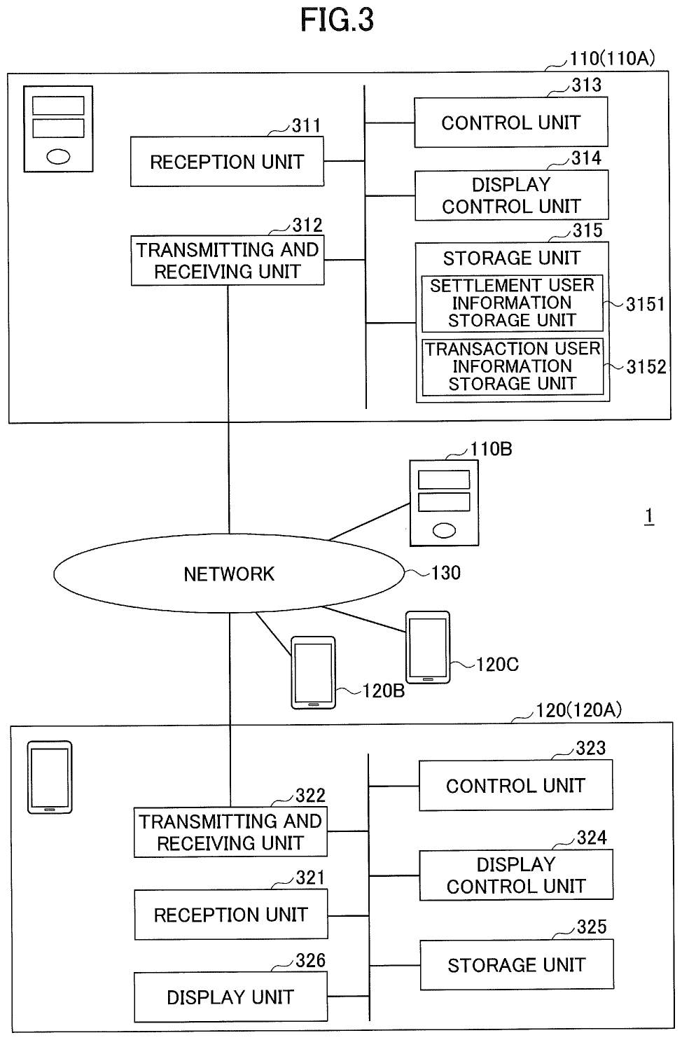

A functional configuration of a server 110 and a terminal 120 will be described with reference to FIG. 3. FIG. 3 is a diagram depicting a block diagram of an example of a functional configuration of a server 110 and a terminal 120 according to the embodiments. The functional units disclosed in FIG. 3 are implemented as a result of the processor 201, the memory 202, the storage 203, the input/output I/F 204, and the communication I/F 205 of the information processing apparatus 200 functioning in a cooperative manner.

### (1) Server's Functional Configuration

A server 110 includes a reception unit 311, a transmitting and receiving unit 312, a control unit 313, a display control unit 314, and a storage unit 315. The function or processing of each of these functional units may be implemented with the use of machine learning or artificial intelligence (AI) to the extent possible.

The reception unit 311 receives various setting operations of a business operator who manages various services provided by the server 110.

The transmitting and receiving unit 312 transmits data to and receives data from a terminal 120 via the network 130 according to instructions of the control unit 313. After the user of the terminal 120 is authenticated on the basis of, for example, the user ID and the password included in a login request sent from the terminal 120, the transmitting and receiving unit 312 establishes a session for communicating with the terminal 120 using HTTPS, for example. The transmitting and receiving unit 312 associates the address of, for example, the terminal 120 as well as the user ID or a shop ID with the ID of the established session, and stores the corresponding information. Then, data is transmitted to, for example, the terminal 120 through the established session.

The control unit 313 performs a process for providing a service such as an electronic commerce service to the user of a terminal 120. The control unit 313 performs a process of offering a loan to the user on the basis of, for example, the degree of financial demand of the user.

The display control unit 314 causes the transmitting and receiving unit 312 to transmit information for controlling a display screen page of, for example, a terminal 120 according to instructions of the control unit 313.

The storage unit 315 includes a settlement user information storage unit 3151 for storing user information with respect to a settlement service and a transaction user information storage unit 3152 for storing user information with respect to a transaction service.

### (2) Functional Configuration of Terminal

A terminal 120 includes a reception unit 321, a transmitting and receiving unit 322, a control unit 323, a display control unit 324, a storage unit 325, and a display unit 326. The function or processing of each of these functional units may be implemented with the use of machine learning or AI to the extent possible.

The reception unit 321 receives various operations from the user of the terminal 120.

The transmitting and receiving unit 322 transmits data to and receives data from a server 110 according to instructions of the control unit 323. For example, when logging in to a server 110, the transmitting and receiving unit 322 establish a session for communicating with the server 110 using HTTPS, for example. The transmitting and receiving unit 322 associates, for example, the address of the server 110, for communication, with the ID of the established session and stores the corresponding information. The transmitting and receiving unit 322 transmits data to the server 110 using the established session.

The control unit 323 performs processing for using various services such as a settlement service provided by a server 110.

The display control unit 324 controls the display unit 326 on the basis of, for example, information received from a server 110 according to instructions of the control unit 323.

The storage unit 325 stores information for using, for example, a service provided by a server 110.

The display unit 326 performs displaying in accordance with instructions of the display control unit 324.

### <Processing of Embodiments>

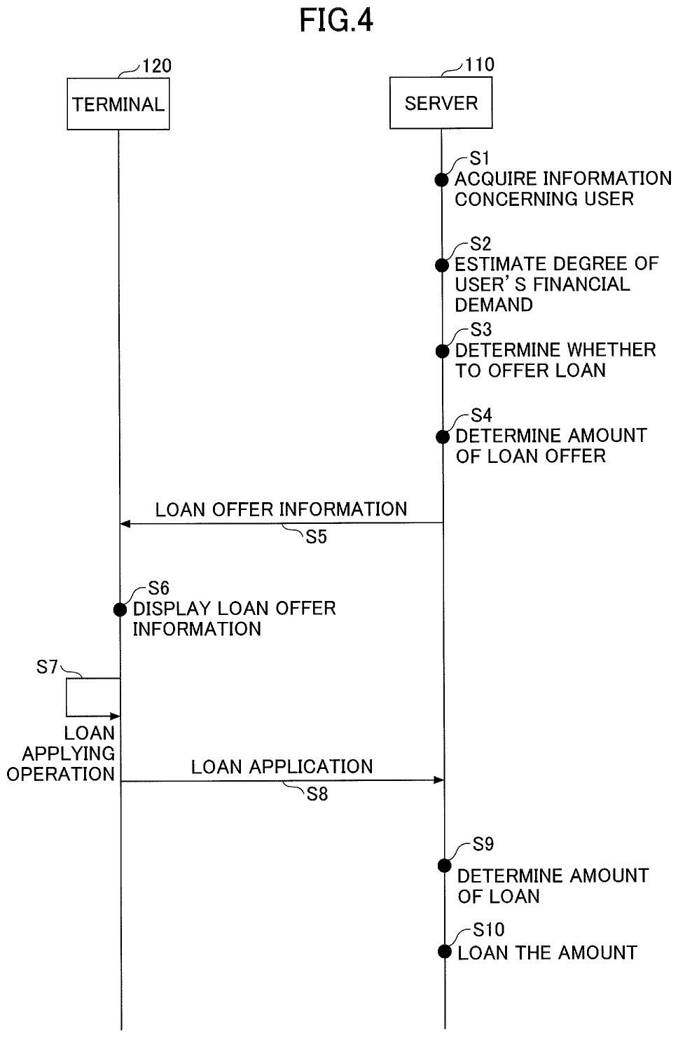

Referring to FIG. 4, processing of the communication system 1 according to the embodiment will be described. FIG. 4 is a diagram depicting a sequence of an example of processing of the communication system 1 according to the embodiment. In the example that will now be described, before communicating with a server 110, a terminal 120 is authenticated by the server 110 with the use of the user's account.

In step S1, the server 110 acquires information concerning the user of the terminal 120. Subsequently, in step S2, the server 110 estimates the degree of financial demand of the user of the terminal 120 on the basis of the information concerning the user of the terminal 120. This process will be described later in more detail.

Subsequently, in step S3, the server 110 determines whether to offer a loan to the user on the basis of the estimated degree of financial demand of the user. In this regard, the server 110 may determine to offer a loan to the user when the score as the estimated degree of financial demand of the user is greater than or equal to a predetermined threshold, for example.

The server 110 may determine not to offer a loan to the user even if the score as the estimated degree of financial demand of the user is greater than or equal to the predetermined threshold in a case where the user meets predetermined conditions. For example, the server 110 may determine not to offer a loan to the user, for example, in a case where the user is determined to belong to an antisocial force, in a case where a prior loan application was not approved after examination, or in a case where the user has not paid for a commodity even after passing of the due date of deferred payment after purchasing the commodity using a deferred payment settlement system with respect to a transaction service.

In a case where there is a possibility that the user has opened a plurality of accounts with respect to, for example, a settlement service, the server 110 may determine not to offer a loan to the user. For example, in a case where the user has opened a plurality of accounts with respect to the same terminal ID (such as the telephone number or the product serial number) of the terminal 120, in a case where the user has opened a plurality of accounts with respect to the same address and name, or in a case where the user has opened a plurality of accounts for which the same IP address has been used to open the accounts, the server 110 may determine that there is a possibility that the user has opened a plurality of accounts with respect to a settlement service, for example.

Upon determining to present a loan offer to the user, the server 110 determines the amount of the loan to be offered (step S4) and transmits information offering the loan (i.e., loan offer information) to the terminal 120 (step S5). In this regard, the server 110 may display, from the terminal 120, information offering a loan when an application for the user to use various services provided by the server 110, such as a transaction service and a settlement service, is activated in the terminal 120, for example. As a result, for example, information offering a loan can be caused to be displayed when the user views information of a commodity or content and when the user purchases a commodity at a shop, for example. The server 110 may, for example, display, from the terminal 120, information offering a loan on various screen pages, such as a home screen page, a lock screen page (i.e., a wallpaper screen page; or a standby screen page), and an application executing screen page, using a notification function provided by an operating system (OS) of the terminal 120, for example. This ensures that information offering a loan can be displayed instantly.

In step S6, the terminal 120 thus displays information offering a loan on the screen. Subsequently, in step S7, the terminal 120 receives the user's operation of applying for a loan. At this time, the terminal 120 receives, for example, an input of the occupation, the annual income, a desired loan amount, and so forth from the user.

Subsequently, the terminal 120 transmits the loan application to the server 110 (step S8). The loan application may include, for example, the user ID and other information, input by the user, such as the occupation, the annual income, and the desired loan amount.

Subsequently, the server 110 determines the amount of the loan (step S9) and loans the amount to the user of the terminal 120 (step S10). In this regard, the server 110 may, for example, read the user information registered by the user of the terminal 120 with respect to a settlement service and acquire personal information such as the name, telephone number, address, and birth date of the user stored in association with the received user ID.

In addition, the server 110 may acquire the user's credit information from a designated credit bureau, calculate the maximum amount (i.e., the limit amount or the credit limit) that can be loaned to the user on the basis of the acquired credit information, and loan the amount when the amount of the loan applied for by the user is less than or equal to the maximum amount.

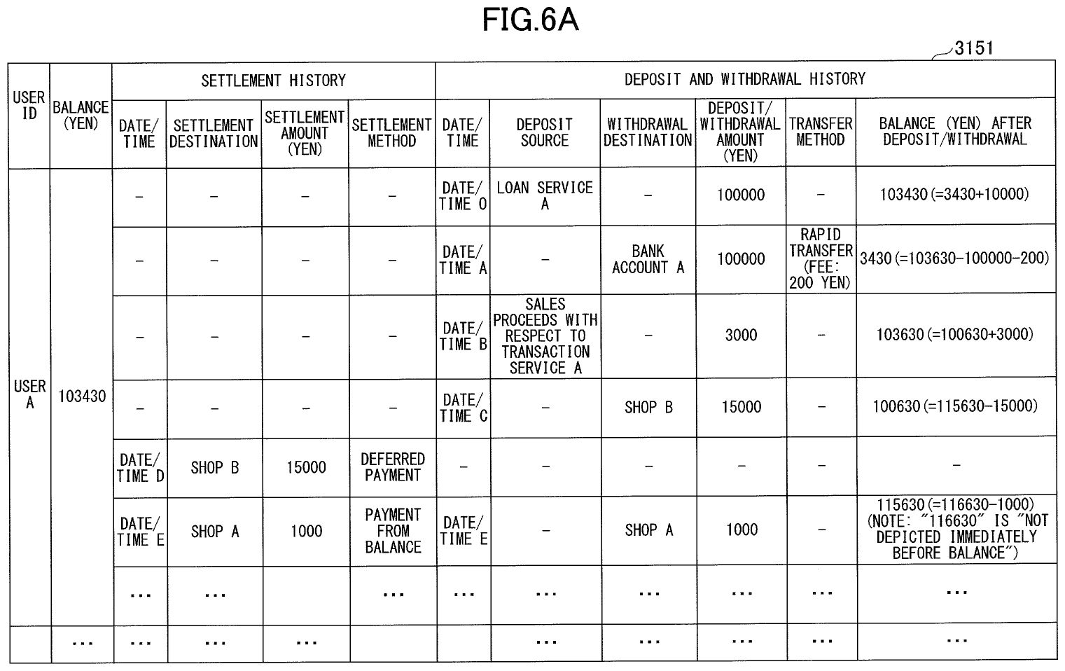

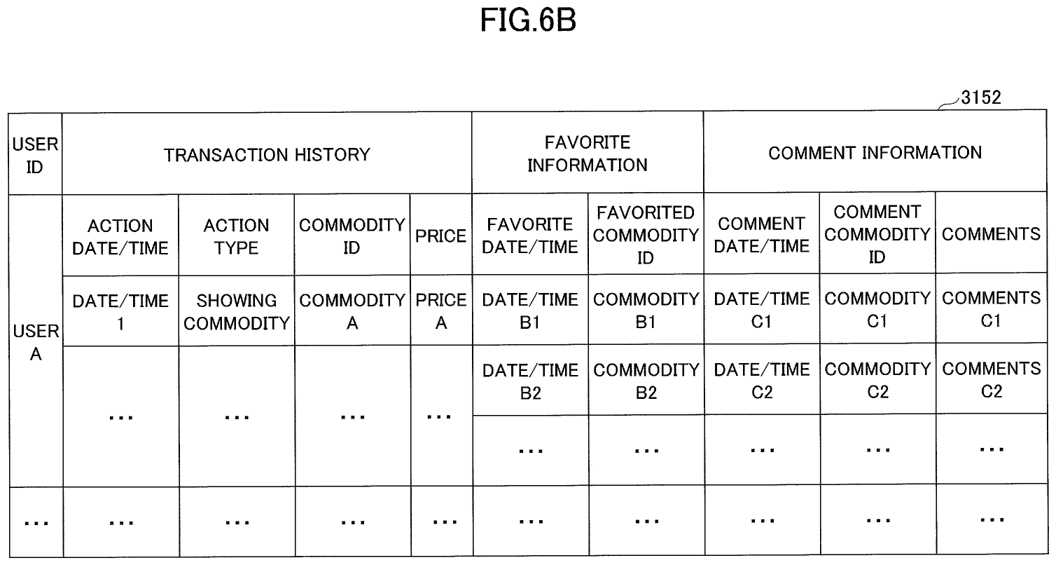

The server 110 may, for example, add the loaned amount to the balance of the user with respect to a settlement service. In the example of the user information with respect to a settlement service of FIG. 6A, which will be described later, a loan of 100,000 yen provided by “loan service A” which is a loan service provided by the server 110 is added to the balance of the user A.

### <<Process of Estimating Degree of Financial Demand>>

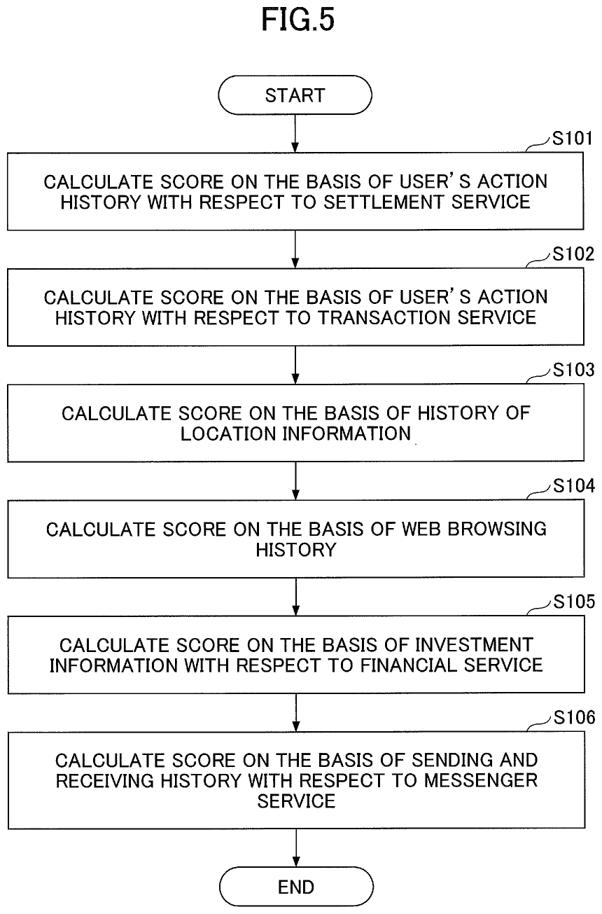

Referring to FIGS. 5-6B, an example of a process of estimating the degree of financial demand of the user in step S2 of FIG. 4 will now be described. FIG. 5 is a flowchart depicting an example of an estimation process for the degree of financial demand of the user according to the present embodiment. FIG. 6A is a diagram depicting an example of settlement user information stored in the settlement user information storage unit 3151 according to the present embodiment. FIG. 6B is a diagram depicting an example of transaction user information stored in the transaction user information storage unit 3152 according to the present embodiment. The server 110 may perform the following processing periodically, or may perform the following processing when some of various information regarding the user is changed by the user as a result of one of various services provided by the server 110 being used by the user, for example. The following processing is performed for each of a plurality of users. The server 110 need not perform all of the following operations; may combine necessary steps; or may complete all or some of the steps as one step. Thus, the server 110 can modify the following operations as appropriate.

In step S101, the server 110 calculates a score as the degree of financial demand of the user on the basis of the user's action history with respect to a settlement service. For example, the server 110 calculates the score as the degree of financial demand of the user on the basis of the settlement user information stored in the settlement user information storage unit 3151.

In the example of FIG. 6A, balance, settlement history, and deposit and withdrawal history are stored in the settlement user information storage unit 3151 in association with the user ID. The user ID is user identification information. The balance is the current balance of the user with respect to a settlement service provided by the server 110. The balance may include, for example, the money amount charged from a bank account, from a store such as a convenience store, from an automated/automatic teller machine (ATM), or the like; the price of a commodity sold by the user using a transaction service of the server 110 (i.e., the sales proceeds); points provided as a privilege when the user purchases a commodity using a transaction service of the server 110; or the like. The balance may also include, for example, money (i.e., points, virtual money, money in a game, or the like) valid with respect to a content-providing service that provides content such as a game or a comic strip purchased by the user. Such money valid with respect to a game may be called a unique name of units for each game provided by the server 110, such as “XXX coins”, “XXX points”, “XXX stones”, or “XXX keys”. The server 110 may be able to use a predetermined type of electronic value included in the balance to be transferred to a bank account, to be withdrawn from an ATM as cash, or the like, for example. The predetermined type of electronic value may be, for example, the price of a commodity sold by the user using a transaction service of the server 110 (i.e., the sales proceeds), electronic value loaned from a financing service of the server 110, or the like.

The settlement history is the history of the user's performing a settlement using a settlement service provided by the server 110, for example. The settlement history includes, as depicted in FIG. 6A, the settlement destination, the settlement amount, and the settlement method in association with the date/time. The settlement destination is the destination to which the payment is made. The settlement amount is the amount of money paid. The settlement method is the payment method. The settlement method may be, for example, payment from the balance, deferred payment, installment payment, or the like. Deferred payment is a method of settlement in which a commodity is received first and payment is made later. Installment payment is a method of settlement in which at least a partial amount, not all, of the price is paid in installments after the commodity is received.

The deposit and withdrawal history is the history of the user's deposits and withdrawals using a settlement service provided by the server 110, for example. Withdrawals may include, for example, settlement (payment), transfer to another user, transfer to a bank account, or the like. The deposit and withdrawal history includes, in association with date/time, deposit source, withdrawal destination, deposit/withdrawal amount, transfer method, and balance after the deposit/withdrawal. The transfer method is the method of transfer from the balance of the user with respect to a settlement service to the user's bank account.

The transfer method may be a normal transfer method (an example of a “first transfer method”) where the transfer from the balance to the bank account occurs after a first period (for example, the fourth business day from the closing date of the transfer application assuming that Monday is determined as the closing date of the transfer application) after the user applies for the transfer by paying a fee (an example of a “first fee”) of a first amount that is 0 yen or more (for example, 0 yen (i.e., free if the transfer amount is 10,000 yen or more) and 210 yen if the transfer amount is less than 10,000 yen). Alternatively, the transfer method may be a rapid transfer method (an example of a “second transfer method”) where the transfer from the balance to the bank account occurs after a second period (for example, the next business day) shorter than the first period after the user applies for the transfer by paying a fee (an example of a “second fee”) of a second amount higher than the first amount (for example, 200 yen higher than the first amount).

For example, the more frequently (the more the number of times within a predetermined period) the user uses the rapid transfer method for transferring the price (the sales proceeds) of a commodity sold by the user to the user's bank account using a transaction service, the higher the server 110 may assign the score as the degree of financial demand of the user. This is because users who wish to realize the users' sales proceeds relatively quickly even with paying relatively high fees seem to need funds immediately.

In another example, the more frequently the user uses deferred payment or installment payment for a settlement, the higher the server 110 may assign the score as the degree of financial demand of the user. In a yet another example, the greater the sum of the amounts of settlements using deferred payment or installment payment within an immediately-before predetermined period, the higher the server 110 may assign the score as the degree of financial demand of the user. This is because users using deferred payments or installment payments seem to need funds immediately.

In addition, the server 110 may assign a higher score as the degree of financial demand of the user when the rate of decrease of the user's balance with respect to a settlement service is equal to or greater than a threshold. This is because users with high rates of decrease in their balances seem to need funds immediately.

In this regard, the server 110 may calculate, as the rate of decrease in the balance, the percentage of the decrease in the balance at the end of a predetermined period (e.g., the present time) compared to the balance at the start of the predetermined period (e.g., one week ago), for example. Alternatively, the server 110 may calculate, as the rate of decrease in the balance, the money amount of the decrease in the balance at the end of a predetermined period compared to the balance at the start of the predetermined period, for example.

The server 110 may assign a higher score as the degree of financial demand of the user when the user's settlement using a settlement service is rejected (an error) due to a shortage of the balance. This is because users having shortages of the balances seem to need funds immediately.

For example, the server 110 may assign a higher score as the degree of financial demand of the user for a case where a settlement using a credit card indicated by the user results in an error caused by the issuer of the credit card at the time of settlement with respect to a transaction service, for example. In another example, the server 110 may assign a higher score as the degree of financial demand of the user when the user attempts to perform, for example, a two-dimensional code settlement at a shop by using a settlement service and the balance of the user with respect to the settlement service is less than the price of a commodity to be purchased. In yet another example, the server 110 may assign a higher score as the degree of financial demand of the user when the balance of money with respect to a game, for example, is insufficient, for example, for a case where the user attempts to continue the game by paying or attempts to read the next story of a comic strip by paying, using a content-providing service. The server 110 may offer a loan in an amount proportional to the amount of a settlement when the settlement of the user using a settlement service is rejected due to a shortage in the balance. In this case, the server 110 may offer a loan of, for example, 4,000 yen without fraction (i.e., the round figure), when the price to be paid by the settlement is 3,800 yen. As a result, the user can save labor of inputting the desired amount of loan and reduce the possibility of receiving an unnecessarily large amount of loan due to an erroneous input of the amount, for example.

Subsequently, in step S102, the server 110 calculates the score as the degree of financial demand of the user on the basis of the user's action history with respect to a transaction service. In this example, the server 110 calculates the score as the degree of financial demand of the user on the basis of the transaction user information stored in the transaction user information storage unit 3152.

In the example of FIG. 6B, the transaction user information storage unit 3152 stores transaction history, favorite information, and comment information in association with user ID. The transaction history is the user's transaction history. In the example of FIG. 6B, the transaction history includes a set of information, i.e., action date/time, action type, commodity ID, and price. The action date/time is the date and time when the user performed the action indicated by the action type. The action type is the type of action taken by the user with respect to transaction, and may be, for example, showing a commodity, purchasing a commodity, selling a commodity, or the like. The showing a commodity may be offering a commodity for a sale using an interpersonal transaction service, having an estimate (or assessment) on a buying price with respect to an instant purchase service, or the like. The commodity ID is identification information of a commodity for which the user performed the action indicated by the action type. The price is the price of the commodity associated with the commodity ID. In a case where an action type is showing a commodity, the price is the price that is set by the user at the time of showing the commodity. In a case where an action type is purchasing, the price is the price at which the user purchases the commodity. In a case where an action type is selling, the price is the price at which the user sells the commodity.

The favorite information is information concerning a user's favorite setting to a shown commodity (i.e., a user's indication of the commodity as a favorite, a user's indication to watch the commodity, or the like; an example of “predetermined relationship”) implemented by the user by, for example, pressing a heart mark on the commodity. In the example of FIG. 6B, a plurality of sets of the favorite dates/times and the favorited commodity IDs are stored in the favorite information. The favorite date/time is the date and time at which favorite setting has been performed by the user. The favorited commodity ID is the commodity ID of the commodity to which favorite setting has been performed by the user.

The comment information is information of comments transmitted by the user to, for example, the persons who have shown commodities, for example, by inputting comments into the shown commodities. In the example of FIG. 6B, a plurality of sets of comment dates/times, comment commodity IDs, and comments are stored as comment information. The comment date/time is the date and time when the comments were transmitted by the user. The comment commodity ID is the commodity ID of the commodity for which the comments have been transmitted through the user's operation. The comments are the transmitted message (sentence or the like) of comments.

The server 110 may be able to allow a user to access information of a commodity through a relatively simple operation of, for example, clicking a favorited commodity list button or a comment transmitted commodity list button, when favorite setting or comments have been registered by the user. The server 110 may, for example, allow all users to view the comments registered by one user from a display screen page prepared for displaying commodity information. This allows for, for example, an inquiry from one user to the person showing a commodity and an answer from the same person to be seen by other users who are considering to purchase the commodity.

The more frequently (the more the number of times within a predetermined period) the user shows commodities with respect to a transaction service is, for example, the higher the server 110 may assign the score as the degree of financial demand of the user. This is because users who show a large number of commodities within a relatively short period of time, for example, seem to need funds immediately.

The more frequently the commodities shown by the user in a transaction service have been reduced in price, for example, the higher the server 110 may assign the score as the degree of financial demand of the user. This is because users who frequently cut their prices on commodities within relatively short periods of time, for example, seem to need funds immediately.

The more frequently the user sets predetermined relationship, for example, the more frequently the user's favorite settings on commodities have been registered with respect to a transaction service or the more frequently the user's comments on commodities have been registered with respect to a transaction service, the higher the server 110 may assign the score as the degree of financial demand of the user. This is because users who register favorite settings or comments for a large number of commodities within a relatively short period of time, for example, seem to need funds immediately to purchase the large number of commodities.

The more the comments are registered from another user for a commodity on which the predetermined relationship has been set by a user with respect to a transaction service, the higher the server 110 may assign the score as the degree of financial demand of the user. This is because, when the comments of another user are registered on a commodity in which a user has an interest, the corresponding commodity may be purchased by the another user after negotiation of a price reduction, for example, for the commodity.

The server 110 may assign a higher score as the degree of financial demand of the user when the price of a commodity for which the predetermined relationship has been set by the user with respect to a transaction service is reduced by the person, for example, who has shown the commodity, for example. This is because when a commodity in which a user has an interest is reduced in price, the user may wish to purchase the commodity even by receiving a loan.

The server 110 may offer a loan in an amount corresponding to the price of a commodity when the comments from another user has been registered for the commodity in which the predetermined relationship has been set by the user with respect to a transaction service or when the price of the commodity in which the predetermined relationship has been set by the user with respect to a transaction service has been reduced by the person, for example, who has shown the commodity. In this case, the server 110 may offer a loan of, for example, 4,000 yen without fraction (i.e., the round figure), when the price of the commodity is 3,800 yen. Accordingly, the user can save labor of inputting the desired amount of loan and reduce the possibility of receiving an unnecessarily large amount of loan due to an erroneous input of the amount, for example.

Subsequently, in step S103, the server 110 calculates a score as the degree of financial demand of the user on the basis of the history of the user's location information. Then, the server 110 may assign a higher score as the degree of financial demand of the user when the user's location information satisfies conditions corresponding to the location of a predetermined type of shop. For example, the server 110 may assign a higher score as the degree of financial demand of the user when a state of the distance between the user's location and the location of the predetermined type of shop being less than a predetermined threshold continues for a predetermined period of time (e.g., 30 minutes), for example. As a result, in a case where a user is shopping at a high-end fashion store or the like, for example, a loan can be offered to the user.

The server 110 may assign a higher score as the degree of financial demand of the user when the state where the distance between the user's position and the position of a predetermined type of shop is equal to or less than a predetermined threshold continues for a predetermined period (e.g., 30 minutes) and then the state ends. As a result, for example, when a user playing on a game machine in a game parlor, for example, has used up all cash in hand, and leaves the game parlor, a loan can be offered to the user.

Subsequently, in step S104, the server 110 calculates the score as the degree of financial demand of the user on the basis of the user's Web browsing history. For example, in a case where the terminal 120 has received the user's operation indicating consent, the terminal 120 transmits the Web site access history of the terminal 120 to the server 110. The Web site access history may include, for example, information such as cookies recorded in the terminal 120 by the Web browser of the terminal 120. The server 110 may assign a higher score as the degree of financial demand of the user when the user registers a commodity of a relatively high price (e.g., 100,000 yen or more) in a shopping cart (i.e., the Web page for purchase) and has not completed the payment of the commodity (leaving the site), for example. This allows the user to receive a loan offer when the user wants a relatively expensive commodity, such as a travel, for example. In such a case, the server 110 may offer a loan in an amount corresponding to the price of the commodity.

Subsequently, in step S105, the server 110 calculates the score as the degree of financial demand of the user on the basis of the user's investment information with respect to a financial service. For example, the server 110 may assign a higher score as the degree of financial demand of the user when an additional margin is required with respect to a financial product transaction of the user using a financial service. An additional margin is a margin (an additional deposit) required of a user in the event of a shortage of deposit (margin) due to a decrease in the value of a stock purchased on margin or an increase in the value of a stock sold. The server 110 may, when the user does not submit an additional margin by a predetermined date or when the open position is not liquidated by closed trade, forcibly execute closed trade in accordance with the code, for example, and liquidate the open position of the user.

Subsequently, in step S106, the server 110 calculates the score as the degree of financial demand of the user on the basis of the history (the talk history) of the content sent and received by the user using a messaging service such as SNS. The server 110 may estimate the score as the degree of financial demand of the user through machine learning by using a messaging service on the basis of a message sent by the user. In this case, the server 110 may estimate the score as the degree of financial demand of the user through machine learning on the basis of the hash value calculated by a predetermined hash function from the message. For example, when the hash value calculated from the message matches the hash value calculated from a character string such as “please lend money”, for example, the server 110 may assign a higher score as the degree of financial demand of the user. This allows the user to receive a loan offer, when the user has requested a loan to a friend using SNS, for example.

### <<Display Control Process>>

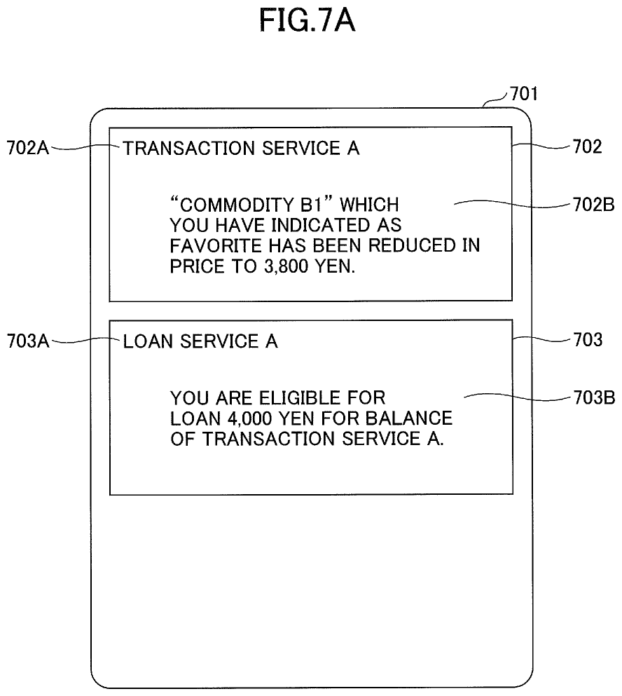

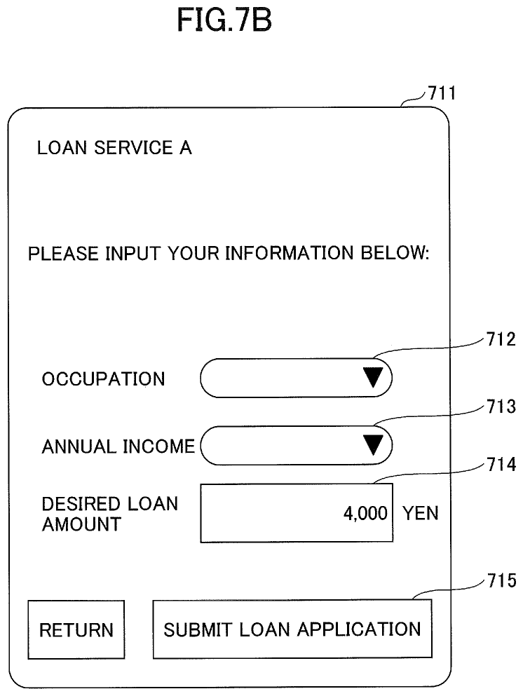

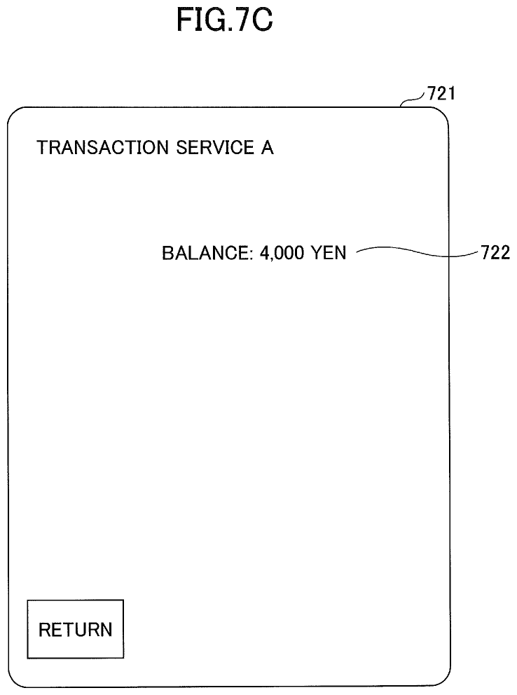

Referring to FIGS. 4 and 7A to 7C, an example of a display control process by a terminal 120 on the basis of information received from the server 110 will now be described. FIGS. 7A-7C are diagrams depicting examples of display screen pages at the terminal 120 according to the embodiment.

In step S6 of FIG. 4, the terminal 120 displays loan offer information as depicted in FIG. 7A at a display screen page 701, for example, a lock screen page. The terminal 120 displays a banner 702 and a banner 703 in the example of FIG. 7A. The banner 702 displays an application name 702A of the information providing source, a “transaction service A”, and a message 702B indicating that a commodity B1 for which you have indicated as a favorite has been reduced in price to 3,800 yen.

In step S102 of FIG. 5 included in step S2 of FIG. 4, the server 110 detects that the price of the “commodity B1” stored as the favorite information depicted in FIG. 6B has been reduced in price, and thus, calculates the score as the degree of financial demand of the user. Then, in step S3 of FIG. 4, the score as the degree of financial demand of the user is used to determine whether to offer a loan in step S3 of FIG. 4. In a case where it is determined in step S3 to offer a loan, a loan amount to be offered to the user is determined in step S4, and loan offer information is transmitted in step S5.

The banner 703 of FIG. 7A, which is displayed in step S6 of FIG. 4, displays an application name 703A of the information providing source a “loan service A”, and a message 703B indicating that you can immediately be loaned 4,000 into the balance of the transaction service A. The loan amount may be determined in such a manner that, taking the current balance of the user into consideration, the sum of the current balance of the user and the loan amount be equal to the necessary amount.

When the user presses the banner 703, the terminal 120 displays a loan application screen page 711, such as the screen page depicted in FIG. 7B. The terminal 120 receives the user's operation to apply for a loan from the loan application screen page 711 in step S7 of FIG. 4. The terminal 120 displays, in the example of FIG. 7B, an occupation entry field 712, an annual income entry field 713, a desired loan amount entry field 714, and a “submit loan application” button 715. In the example of FIG. 7B, the default value in the desired loan amount entry field 714 is 4,000 yen, which is a round figure determined according to the price of 3,800 yen of the “commodity B1” which has been reduced in price as mentioned above. In response to the “submit loan application” button 715 being pressed by the user, the terminal 120 transmits the loan application to the server 110 in step S8 of FIG. 4.

Then, the server 110 determines the loan amount in step S9 of FIG. 4 and loans the amount in step S10. Thereafter, in response to receiving the user's operation to start the application with respect to a “transaction service A”, the terminal 120 displays an application executing screen page 721 with respect to the “transaction service A” depicted in FIG. 7C. In the example of FIG. 7C, the balance 722 of the user of the terminal 120 with respect to the transaction service A which is the transaction service provided by the server 110 is 4,000 yen as a result of 4,000 yen being loaned from the “loan service A” which is a loan service provided by the server 110.

Thus, the information processing methods, the information processing apparatus, and the non-transitory recording media have been described with reference to the embodiments. However, the present disclosure is not limited to the above-described embodiments. Various modifications and improvements may be made within the scope of the present disclosure.

For example, in the present embodiment, the server 110 determines whether to offer a loan to a user on the basis of an estimated score as the degree of financial demand of the user. In this regard, a method of such determination is not limited to this method. Alternatively, the server 110 may determine whether to offer a loan to a user on the basis of whether the user's history and so forth such as the user's action history with respect to a settlement service, the user's action history with respect to a transaction service, the user's history with respect to location information, the user's history with respect to Web browsing, investment information with respect to a financial service, or the user's history with respect to sending and receiving messages with respect to a messenger service satisfies specific conditions.

Further, in the present embodiment, for example, when the estimated score as the degree of financial demand of a user is greater than or equal to a predetermined threshold, it is determined to offer a loan to the user (i.e., it is determined to present a loan offer to the user). However, the present embodiment is not limited to this manner. Alternatively, a determination as to whether to present a loan offer to a user may be based on a change in the score as the degree of financial demand of the user. For example, when the amount of change or the rate of change in the score as the degree of financial demand of a user is greater than or equal to a threshold, it may be determined to present a loan offer to the user.

In the present embodiment, a offered loan amount is determined in step S4 of FIG. 4. However, the present embodiment is not limited to this manner. Alternatively, a loan offer may be transmitted to a terminal 120 without determining a loan amount to be offered.

The present application is based on and claims the priority of Japanese patent application No. 2019-114945, filed on Jun. 20, 2019, the entire contents of which are hereby incorporated herein by reference.

What is claimed is:

1. A method of determining whether or how to present a loan offer to a user, the method comprising:
determining, by at least one processor, whether or how to present a loan offer to a user on the basis of the user's financial demand.

2. The method as claimed in claim 1, wherein
the determining comprises determining whether or how to present a loan offer to a user on the basis of the user's action history with respect to a settlement service.

3. The method as claimed in claim 2, wherein
the determining comprises determining to present a loan offer to a user for a case where the user uses at least one of deferred payment or installment payment with respect to the settlement service.

4. The method as claimed in claim 2, wherein
the determining comprises determining to present a loan offer to a user for a case (i) where (a) a rate of decrease in a balance that the user has with respect to the settlement service is greater than or equal to a threshold or (b) a settlement of the user with respect to the settlement service is rejected due to a shortage of a balance that the user has; or a case (ii) where (a) a rate of decrease in a balance that the user has with respect to the settlement service is greater than or equal to a threshold and (b) a settlement of the user with respect to the settlement service is rejected due to a shortage of the balance that the user has.

5. The method as claimed in claim 1, wherein
the determining comprises determining whether or how to present a loan offer to a user on the basis of the user's action history with respect to a transaction service.

6. The method as claimed in claim 5, wherein
the determining comprises, at least one of:
(i) determining whether or how to present a loan offer to a user on the basis of, at least one of (a) a frequency at which the user shows a commodity with respect to the transaction service. (b) a frequency at which a commodity shown by the user is reduced in price with respect to the transaction service, and (c) a frequency at which the user sets a predetermined relationship on a commodity; and
(ii) determining to present a loan offer to a user for a case where, for a transfer of a price to a bank account for a commodity sold by the user, the user uses a second method of transfer of the price to the bank account, within a second period shorter than a first period of a first method, with a second fee higher than a first fee of the first method.

7. The method as claimed in claim 5, wherein
the determining comprises (i) determining to present a loan offer to a user for a case where (a) comments are registered by another user on a commodity to which a predetermined relationship is set by the user with respect to the transaction service or (b) a commodity to which the predetermined relationship is set by the user is reduced in price; or (ii) determining to present a loan offer to a user for a case where (a) comments are registered by another user on a commodity to which a predetermined relationship is set by the user with respect to the transaction service and (b) the commodity to which the predetermined relationship is set by the user is reduced in price.

8. The method as claimed in claim 7, wherein
the determining comprises (i) determining to present a loan offer of a loan amount corresponding to a price of a commodity to a user for a case where (a) comments are registered by another user on the commodity to which predetermined relationship is set by the user with respect to the transaction service or (b) the commodity to which a predetermined relationship is set by the user is reduced in price; or (ii) determining to present a loan offer of a loan amount corresponding to a price of a commodity to a user for a case where (a) comments are registered by another user on the commodity to which a predetermined relationship is set by the user with respect to the transaction service and (b) the commodity to which the predetermined relationship is set by the user is reduced in price.

9. The method as claimed in claim 1, wherein
the determining comprises determining to present a loan offer to a user for a case where the user's location information satisfies a condition corresponding to a location of a predetermined type of a shop.

10. The method as claimed in claim 1, wherein
the determining comprises determining whether or how to present a loan offer to a user on the basis of the user's Web browsing history.

11. The method as claimed in claim 1, wherein
the determining comprises determining to present a loan offer to a user for a case where an additional margin is required with respect to the user's financial product transaction using a financial service.

12. The method as claimed in claim 1, wherein
the determining comprises determining whether or how to present a loan offer to a user on the basis of content transmitted or received by the user with the use of a messaging service.

13. The method as claimed in claim 1, wherein
the determining comprises determining a loan amount of a loan offer to a user on the basis of a degree of the user's financial demand.

14. The method as claimed in claim 13, wherein
the determining comprises determining a loan amount of a loan offer to a user on the basis of a balance that the user has.

15. An information processing apparatus comprising:
at least one processor configured to determine whether or how to present a loan offer to a user on the basis of the user's financial demand.

16. A non-transitory recording medium storing a program which when executed by at least one processor causes the at least one processor to determine whether or how to present a loan offer to a user on the basis of the user's financial demand.
